(19) United States
(12) Patent Application Publication
(10) Pub. No.: US 2023/0223804 A1
(43) Pub. Date: Jul. 13, 2023

(54) ROTOR AND ROTARY ELECTRIC MACHINE

(71) Applicant: TOYOTA JIDOSHA KABUSHIKI KAISHA, Toyota-shi (JP)

(72) Inventors: Toshinori OKOCHI, Toyota-shi (JP); Jianing DENG, Toyota-shi (JP)

(73) Assignee: TOYOTA JIDOSHA KABUSHIKI KAISHA, Toyota-shi (JP)

(21) Appl. No.: 18/058,299

(22) Filed: Nov. 23, 2022

(30) Foreign Application Priority Data
Jan. 12, 2022 (JP) 2022-003045

(51) Int. Cl. H02K 1/276

(52) U.S. Cl. CPC H02K 1/276; H02K 2213/03

(57) ABSTRACT

A rotor includes a rotor core in which first and second magnet mounting holes, which are located outward and inward in a radial direction, respectively, are provided symmetrically in a circumferential direction about a d-axis, and a magnet provided in each of the first and second magnet mounting holes. The first and second magnet mounting holes satisfy a positional relationship defined by 1.0 < L1/L2 ≤ 1.7, where L1 represents a largest distance between a first magnet, which is disposed closest to the d-axis in the second magnet mounting hole, and a second magnet, which is mounted in the first magnet mounting hole, along a magnetization easy direction, and L2 represents a shortest distance between the first and second magnet mounting holes in a region located closer to the q-axis than a d-axis-side end of a third magnet disposed closest to the q-axis in the second magnet mounting hole.

### CROSS-REFERENCE TO RELATED APPLICATION

This application is based upon and claims the benefit of priority of the prior Japanese Patent Application No. 2022-003045, filed on Jan. 12, 2022, the entire contents of which are incorporated herein by reference.

### FIELD

The present disclosure relates to a rotor and a rotary electric machine.

### BACKGROUND

In an embedded magnet type rotary electric machine in which permanent magnets are embedded in a rotor to form magnetic poles, the combined torque of the magnet torque generated by the permanent magnets and the reluctance torque generated based on the magnetic anisotropy of the rotor core is output torque. Conventionally, to increase the output torque, a technique in which permanent magnets are arranged in two layers along the radial direction of the rotor has been proposed as disclosed in, for example, International Publication No. 2020/057847 and Japanese Patent Application Laid-Open No. 2020-137139 (Patent Documents 1 and 2).

### SUMMARY

In the rotary electric machine, there is a case in which magnetic saturation occurs when a high load is applied, such as when the rotary electric machine is mounted on a vehicle and the vehicle travels uphill, and the output torque corresponding to the input current cannot be obtained. In Patent Document 1 and Patent Document 2, such magnetic saturation may occur, and there is room for improvement in this respect.

Therefore, it is an object of the present disclosure to provide a rotor capable of inhibiting the occurrence of a magnetic saturation state.

According to one aspect of the present disclosure, there is provided a rotor that is rotatably and concentrically disposed inside a stator and in which a plurality of magnetic poles arranged in a circumferential direction with a q-axis interposed therebetween are formed, the rotor including: a rotor core in which magnet mounting holes, which are provided symmetrically in a circumferential direction about a d-axis, are provided in a plurality of layers along a radial direction for each of the magnetic poles; and magnets disposed in the magnet mounting holes, wherein the magnet mounting holes provided in the plurality of layers along the radial direction include a first magnet mounting hole and a second magnet mounting hole, the second magnet mounting hole is located further inward than the first magnet mounting hole in the radial direction, and the first magnet mounting hole and the second magnet mounting hole satisfy a positional relationship defined by the following expressions:

$$\text{L3>L2}$$

$$1.0 < \text{L1} / \text{L2} \leq 1.7$$

where L1 represents a largest distance of distances between a first magnet and a second magnet along a direction in which a magnetic flux flows from a north pole to a south pole of the first magnet, the first magnet being a magnet disposed closest to the d-axis among the magnets mounted in the second magnet mounting hole, the second magnet being a magnet mounted in the first magnet mounting hole among the magnets, the largest distance L1 being not intersecting with the d-axis, L2 represents a shortest distance of distances between the first magnet mounting hole and the second magnet mounting hole in a region located closer to the q-axis than a d-axis-side end of a third magnet in the second magnet mounting hole, the third magnet being a magnet disposed closest to the q-axis among the magnets mounted in the second magnet mounting hole, and L3 represents a shortest distance of distances between the first magnet mounting hole and the second magnet mounting hole in a region located closer to the d-axis than a q-axis-side end of a fourth magnet in the second magnet mounting hole, the fourth magnet being a magnet disposed closest to the d-axis among the magnets mounted in the second magnet mounting hole.

In the above rotor, the rotor core may include a q-axis portion magnetic path that connects the second magnet mounting holes adjacent to each other across the q-axis, and a relationship defined by the following expression:

$$1.0 < \text{q} / \text{L2} \leq 1.2$$

may be further satisfied where q represents a smallest width of the q-axis portion magnetic path.

In the above rotor, in one of the magnetic poles, the first magnet mounting hole may be provided in a plurality, the first magnet mounting holes may be provided symmetrically in the circumferential direction about the d-axis across an outer-side center bridge through which the d-axis passes, and one or more of the magnets may be disposed in each of the first magnet mounting holes..

In the above rotor, in one of the magnetic poles, the first magnet mounting hole may be one hole through which the d-axis passes, and one of the magnets may be disposed in the one hole, the one of the magnets having a rectangular shape, the d-axis passing through the one of the magnets.

In the above rotor, in one of the magnetic poles, the first magnet mounting hole may include a central mounting portion through which the d-axis passes and side mounting portions extending at respective sides of the central mounting portion, and the magnets may be disposed in the central mounting portion and the side mounting portions, respectively.

In the above rotor, in one of the magnetic poles, the second magnet mounting hole may be provided in a plurality, the second magnet mounting holes may be provided symmetrically in the circumferential direction about the d-axis across an inner-side center bridge through which the d-axis passes, and one or more of the magnets may be disposed in each of the second magnet mounting holes..

In the above rotor, two or more of the magnets may be disposed in the second magnet mounting hole in a plurality.

In the above rotor, in one of the magnetic poles, the second magnet mounting hole may have a polygonal line shape having one or more bending points as viewed in an axial direction, and one or more of the magnets may be provided in each of regions on both sides of the bending points.

In the above rotor, each of the magnets may have a curved shape as viewed in an axial direction.

According to another aspect of the present disclosure, there is provided a rotary electric machine including the above rotor.

### BRIEF DESCRIPTION OF THE DRAWINGS

FIG. 1 is a schematic configuration diagram schematically illustrating a rotary electric machine including a rotor in accordance with an embodiment;

FIG. 2 is a cross-sectional view of the rotary electric machine including the rotor in accordance with the embodiment;

FIG. 3 is a cross-sectional view of the rotor according to the embodiment;

FIG. 4 is an explanatory diagram schematically illustrating the flow of the main magnetic flux in the rotor of the embodiment;

FIG. 5 is an explanatory view schematically illustrating the flow of the magnet magnetic flux in the rotor of the embodiment;

FIG. 6A is an explanatory view illustrating a distance L1, a distance L2, a distance L3, and a smallest width q in the rotor core included in the rotor of the embodiment, and FIG. 6B is an explanatory view illustrating the direction (the magnetization easy direction) in which the magnetic flux flows from the north pole to the south pole in an inner magnet;

FIG. 7A is an explanatory view illustrating the distance L1 adopted in the rotor of the embodiment, and FIG. 7B is an explanatory view illustrating the distance L1 intersecting with the d-axis;

FIG. 8 is an explanatory view illustrating the distance L3 adopted in the rotor of the embodiment;

FIG. 9 is an explanatory view illustrating the distance L3 adopted in a rotor of another embodiment;

FIG. 10 is an explanatory view illustrating the distance L3 employed in a rotor of yet another embodiment;

FIG. 11 is a graph presenting an example of output characteristics set when the rotary electric machine including the rotor of the embodiment is mounted on a vehicle;

FIG. 12 is a graph presenting a relationship between an L1/L2 ratio in the rotor and a torque under high load of the rotary electric machine mounted on the vehicle;

FIG. 13 is a graph presenting a relationship between the L1/L2 ratio in the rotor and a torque under low load of the rotary electric machine mounted on the vehicle;

FIG. 14 is a graph presenting a relationship between the L1/L2 ratio and the torque under high load and the torque under low load of the rotary electric machine mounted on the vehicle;

FIG. 15 is a graph presenting a relationship between q/L2 in the rotor and the torque of the rotary electric machine;

FIG. 16 is an enlarged explanatory view illustrating the periphery of a portion forming one magnetic pole in a rotor in accordance with a first variation;

FIG. 17 is an enlarged explanatory view illustrating the periphery of a portion forming one magnetic pole in a rotor in accordance with a second variation;

FIG. 18 is an enlarged explanatory view illustrating the periphery of a portion forming one magnetic pole in a rotor in accordance with a third variation; and

FIG. 19A is an explanatory view illustrating a magnet having a rectangular shape as viewed in the axial direction, and FIG. 19B is an explanatory view illustrating a magnet having a curved shape as viewed in the axial direction.

### DETAILED DESCRIPTION

Hereinafter, embodiments of the present disclosure will be described with reference to the accompanying drawings. However, in the drawings, the dimensions, ratios, and the like of the respective portions may not be illustrated so as to completely match actual ones. In addition, details may be omitted in some drawings.

### Embodiment

### Configuration of Rotary Electric Machine

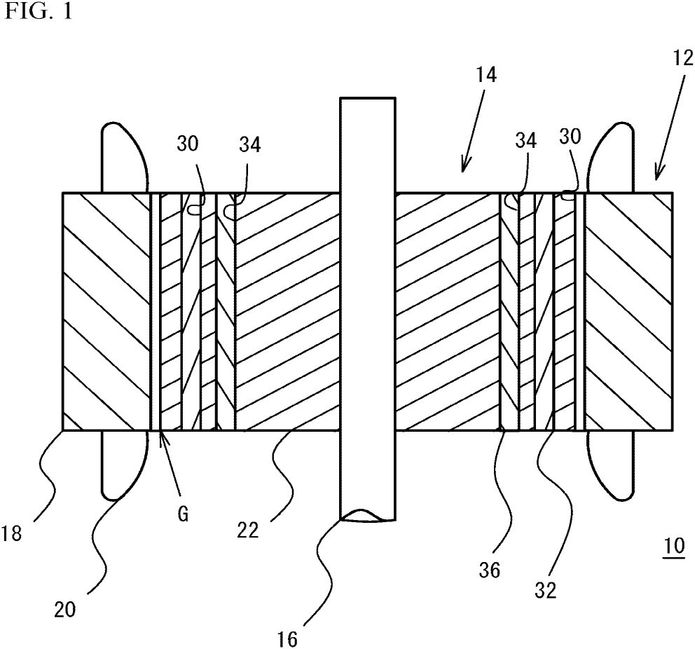

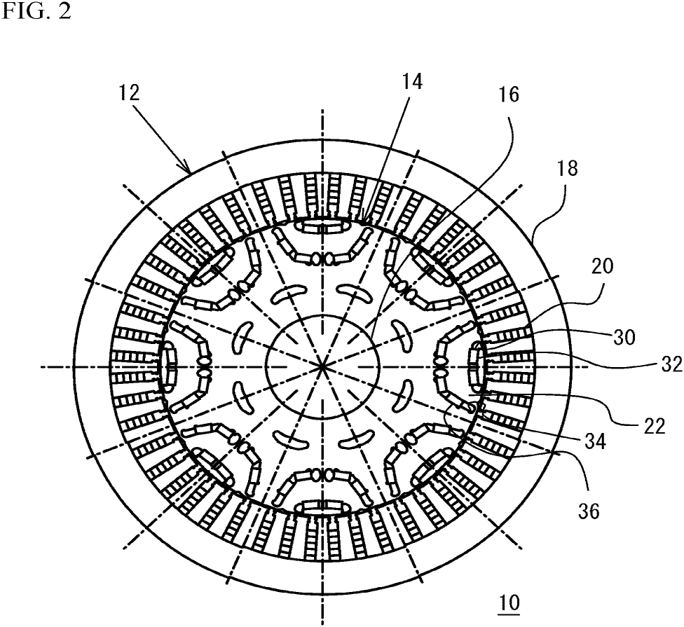

FIG. 1 and FIG. 2 schematically illustrates a rotary electric machine 10 including a rotor 14 in accordance with an embodiment. The rotary electric machine 10 is a permanent magnet synchronous rotary electric machine in which permanent magnets 32 and 36 are embedded in a rotor core 22, a so-called interior permanent magnet (IPM) motor. The rotary electric machine 10 is used as, for example, an electric motor, a generator, or a motor generator having both functions of an electric motor and a generator. The rotary electric machine 10 is used, for example, as a traveling motor or a motor generator for a hybrid vehicle in which an engine and a traveling motor are mounted as drive sources of the vehicle, an electric vehicle such as a battery vehicle or a fuel cell vehicle. In the following description, the “axial direction”, the “radial direction”, and the “circumferential direction” mean the axial direction of the rotor, the radial direction of the rotor, and the circumferential direction of the rotor, respectively.

The rotary electric machine 10 includes a substantially cylindrical stator 12, the rotor 14 disposed concentrically inside the stator 12, and a rotating shaft 16 fixed to the center of the rotor 14. The stator 12 includes a substantially cylindrical stator core 18 having a plurality of teeth (not illustrated) formed on the inner periphery thereof, and stator coils 20 wound around respective teeth. A gap G having a substantially uniform distance is formed between the outer peripheral surface of the rotor 14 and the inner peripheral surface of the stator 12.

In the present embodiment, the stator 12 includes three phases: the U phase, the V phase, and the W phase, and the stator coils 20 are wound by distributed winding (not illustrated). The stator core 18 is provided with 24 slots in the circumferential direction, and coils are disposed in the respective slots. That is, the rotary electric machine 10 of the present embodiment forms a 24-slot 8-pole motor.

In the rotor 14, magnetic poles 24 are formed by the substantially cylindrical rotor core 22 and the permanent magnets 32 and 36 embedded in the rotor core 22. The rotating shaft 16 is fixed to the center of the rotor core 22, and the rotating shaft 16 is supported by a bearing (not illustrated) and rotates together with the rotor 14.

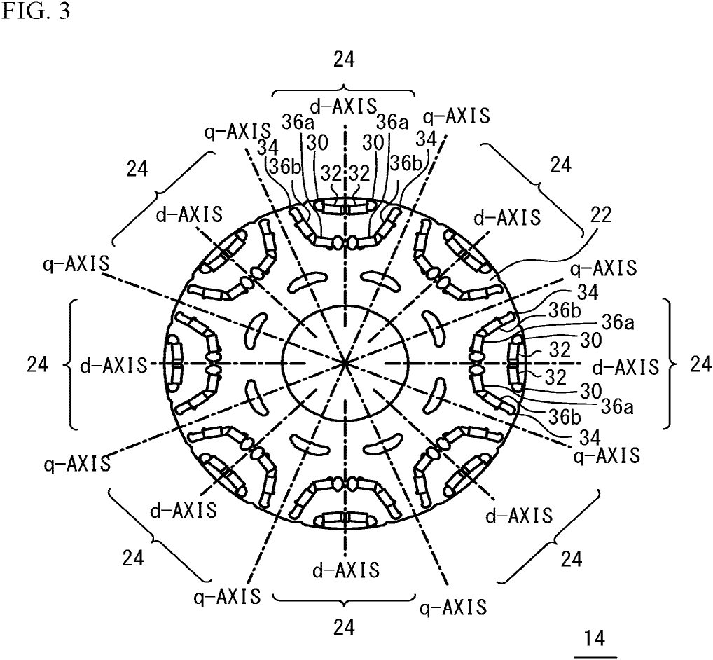

As illustrated in FIG. 3, in the rotor 14, an even number (eight in FIG. 3) of the magnetic poles 24 arranged at equal intervals in the circumferential direction with the q-axis interposed therebetween are formed. The polarities of the even number of the magnetic poles 24 are alternately reversed in the circumferential direction. In the rotor core 22 included in the rotor 14, first magnet mounting holes 30 and second magnet mounting holes 34 that are provided in a plurality of layers along the radial direction and are provided symmetrically in the circumferential direction about the d-axis are provided for each magnetic pole 24. One outer magnet 32 is disposed in each of the first magnet mounting holes 30 located in the outer side of the rotor core 22. On the other hand, inner magnets 36a and 36b are disposed in each of the second magnet mounting holes 34, which are provided in the inner side of the rotor core 22, i.e., are located further in than the first magnet mounting holes 30. In the present embodiment, two layers of magnet mounting holes are provided in the radial direction, but the number of layers may be three or more.

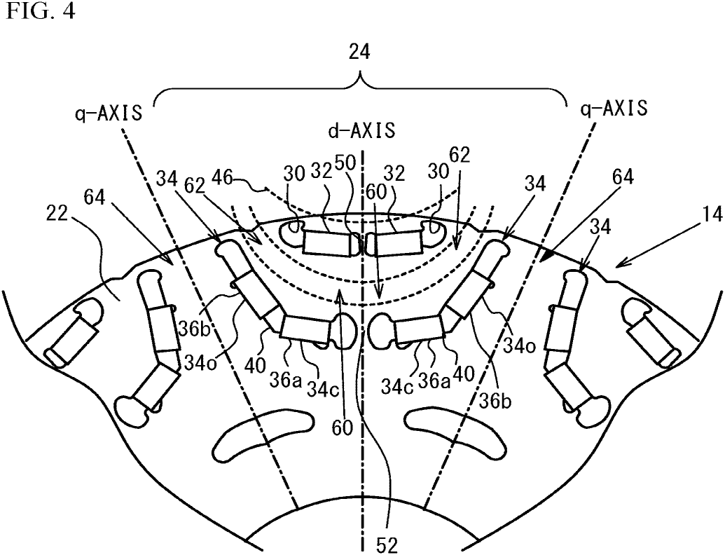

The first magnet mounting holes 30 are arranged symmetrically in the circumferential direction about the d-axis in each magnetic pole, and each first magnet mounting hole 30 is a hole penetrating through the rotor core 22 in the axial direction. Each of the first magnet mounting holes 30 has a substantially rectangular outer shape (a rectangular shape) elongated in one direction as viewed in the axial direction. Each first magnet mounting hole 30 is inclined so as to be more distant from the d-axis at closer distances to the outer peripheral edge of the rotor 14 in the radial direction, whereby the two first magnet mounting holes 30 form a substantially V-shape as illustrated in FIG. 4. An outer-side center bridge 50, which is a part of the rotor core 22, is interposed between the two first magnet mounting holes 30.

Similarly to the first magnet mounting hole 30, each outer magnet 32 has a substantially rectangular outer shape as viewed in the axial direction. Each outer magnet 32 is magnetized in its thickness direction (the short axis direction). The dimension of the outer magnet 32 in the width direction (the long axis direction) is sufficiently smaller than the dimension of the first magnet mounting hole 30 in the width direction. Therefore, when the outer magnet 32 is mounted in the first magnet mounting hole 30, gaps are formed on both sides of the outer magnet 32 in the width direction. This gap functions as a flux barrier that inhibits the flow of magnetic flux.

The second magnet mounting hole 34 is provided further inward than the first magnet mounting hole 30 in the radial direction, and a pair of the second magnet mounting holes 34 arranged symmetrically in the circumferential direction about the d-axis are provided so as to form a substantially V shape or a substantially U shape. Similarly to the first magnet mounting holes 30, the second magnet mounting holes 34 are holes that penetrate through the rotor core 22 in the axial direction. However, the second magnet mounting hole 34 has a polygonal-line-shaped outer shape having one or more bending points 40 as viewed in the axial direction. More specifically, the second magnet mounting hole 34 of the present embodiment has a substantially V-shaped outer shape having a center-side portion 34c extending from the bending point 40 toward the center of the magnetic pole 24 and an outer-side portion 34o extending from the bending point 40 toward the outer peripheral edge of the rotor 14. An inner-side center bridge 52, which is a part of the rotor core 22, is interposed between the two second magnet mounting holes 34.

Two inner magnets 36 are mounted in each second magnet mounting hole 34. The two inner magnets 36 are arranged at both sides of the bending point 40. That is, one inner magnet 36 is mounted in the center-side portion 34c and another inner magnet 36 is mounted in the outer-side portion 34o of the second magnet mounting hole 34. Similarly to the outer magnet 32, the inner magnet 36 also has a substantially rectangular outer shape as viewed in the axial direction, and is magnetized in the thickness direction (the short axis direction) thereof.

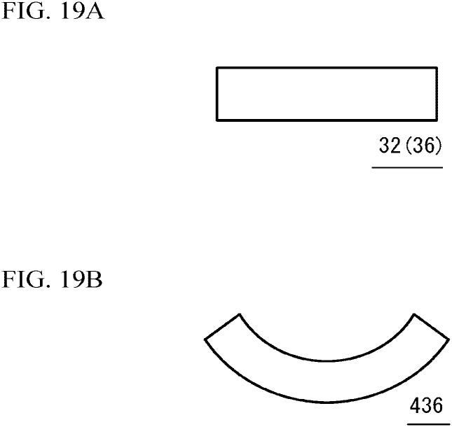

FIG. 19A illustrates the shapes of the outer magnet 32 and the inner magnet 36 as viewed in the axial direction, but instead of such a substantially rectangular shape, a magnet 436 having a curved shape as viewed in the axial direction as illustrated in FIG. 19B may be used. Further, the outer magnet 32 and the inner magnet 36 in the present embodiment have the same shape and the same volume, and the outer magnet 32 and the inner magnet 36 have the same composition and the same characteristics. However, magnets having different shapes and volumes may be adopted for respective positions where the permanent magnet is disposed. In addition, magnets having different compositions and different characteristics may be adopted for respective positions where the permanent magnet is disposed.

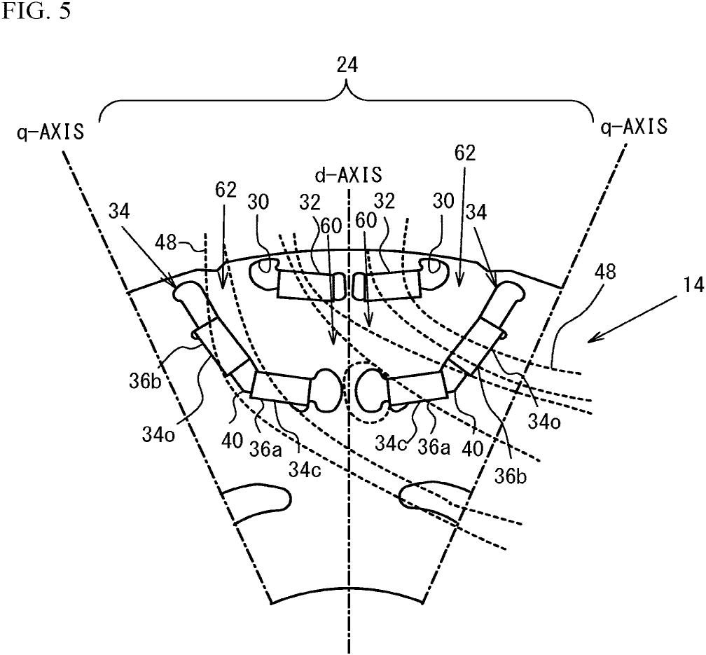

Next, the magnetic flux flowing through the rotor 14 of the present embodiment will be described with reference to FIG. 4 and FIG. 5. FIG. 4 schematically illustrates main magnetic flux 46, and FIG. 5 schematically illustrates magnet magnetic flux 48. The output torque of the permanent magnet synchronous rotary electric machine employed in the rotary electric machine 10 of the present embodiment is a combined torque of the reluctance torque and the magnet torque. The reluctance torque is a torque generated by an attractive force between the poles due to the rotating magnetic field of the stator 12 and the salient poles of the rotor 14. The reluctance torque increases as the amount of the main magnetic flux 46 flowing in the substantially circumferential direction across the d-axis in the rotor core 22 increases. The magnet torque is a torque generated by attraction and repulsion between the poles of the rotating magnetic field of the stator 12 and the magnetic poles 24 of the rotor 14.

The magnet torque increases as the amount of the magnet magnetic flux 48 flowing through the permanent magnets 32 and 36 increases in the rotor core 22. In the present embodiment, a two-layer structure in which the first magnet mounting hole 30 and the second magnet mounting hole 34 are provided, and the permanent magnets 32 and 36 are mounted in the respective magnet mounting holes is employed. Therefore, the number of the permanent magnets 32 and 36 can be increased and the total amount of the magnet magnetic flux 48 can be thereby increased as compared with the case of a single-layer arrangement. In the present embodiment, two outer magnets 32 are mounted in one second magnet mounting hole 34. As a result, the number of the permanent magnets 32 and 36 can be increased and the magnet magnetic flux 48 can be thereby increased as compared with the case in which only one inner magnet 36 is mounted in one second magnet mounting hole 34. By increasing the amount of the magnet magnetic flux 48, the output torque of the rotary electric machine 10 can also be improved.

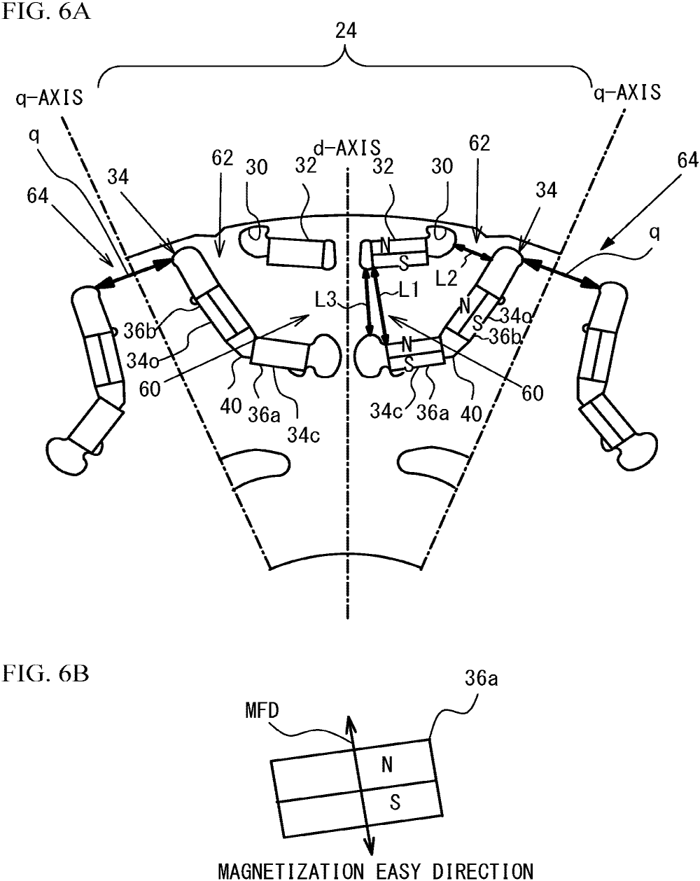

However, there is an upper limit to the amount of magnetic flux that can pass through the magnetic path. Therefore, when the main magnetic flux 46 and the magnet magnetic flux 48 increase and magnetic saturation occurs in the magnetic path, the output torque cannot be efficiently derived. In addition, the output balance between a high load and a low load may deteriorate. Therefore, in the present embodiment, as illustrated in FIG. 6A, a dimensional relationship among an inner peripheral side magnetic path 60, an outer peripheral side magnetic path 62, and a q-axis portion magnetic path 64 is defined to inhibit the magnetic saturation, and thereby, a desired output torque required from the vehicle on which the rotary electric machine 10 is mounted is obtained.

Here, as illustrated in FIG. 6A, the inner peripheral side magnetic path 60 is a magnetic path formed in a part connecting the first magnet mounting hole 30 and the second magnet mounting hole 34 at a side closer to the d-axis in each magnetic pole 24. The outer peripheral side magnetic path 62 is a magnetic path formed in a part connecting the first magnet mounting hole and the second magnet mounting hole at a side closer to the q-axis in each magnetic pole 24. The inner peripheral side magnetic paths 60 are formed symmetrically about the d-axis in each magnetic pole 24, and the outer peripheral side magnetic paths 62 are formed symmetrically about the d-axis in each magnetic pole 24. Further, the q-axis portion magnetic path 64 is a magnetic path formed in a part connecting the second magnet mounting holes 34 adjacent to each other across the q-axis.

In the rotor 14 included in the rotary electric machine 10 of the present embodiment, the first magnet mounting hole 30 and the second magnet mounting hole 34 have the following positional relationships.

$$\text{L3>L2}$$

$$1.0 < \text{L1} / \text{L2} \leq 1.7$$

$$1.0 < \text{q} / \text{L2} \leq 1.2$$

The distance L1 is the largest distance of the distances between the inner magnet 36a and the outer magnet 32 measured along the magnetization easy direction MFD of the inner magnet 36a. Here, the inner magnet 36a and the inner magnet 36b are mounted in the second magnet mounting hole 34, but the distance L1 is measured for the inner magnet 36a. That is, the distance L1 is measured for the magnet disposed closest to the d-axis of the inner magnets 36a and 36b mounted in the second magnet mounting hole 34, i.e., for the inner magnet 36a of the inner magnets 36a and 36b illustrated in FIG. 6A.

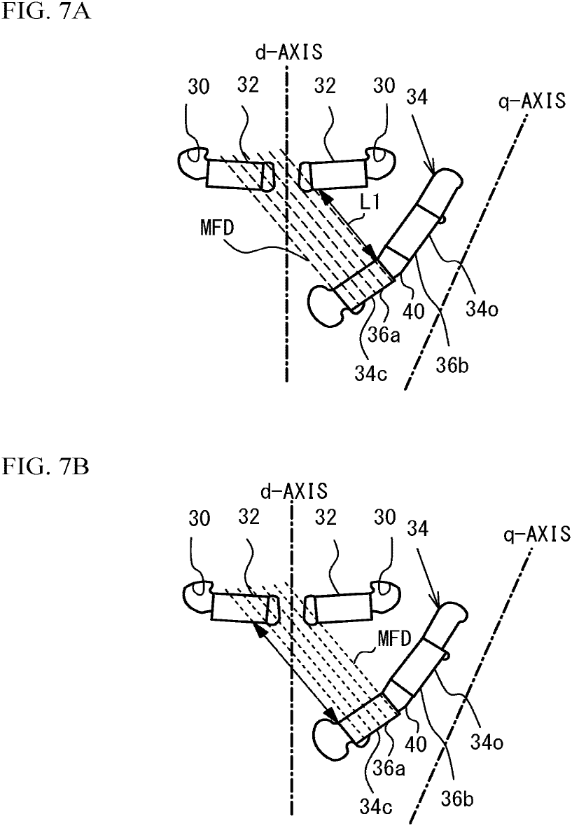

Here, the magnetization easy direction MFD will be described. As illustrated in FIG. 6B, a north (N) pole and a south (S) pole are formed in the inner magnet 36a along the short side direction. In the inner magnet 36a, a direction in which the magnetic flux flows from the north pole to the south pole is the magnetize easy direction MFD. In FIG. 7A, each of broken lines drawn in parallel indicates the magnetization easy direction MFD. As illustrated in FIG. 7A, the distance L1 is the largest distance of the distances between the inner magnet 36a and the outer magnet 32 measured along the magnetization easy direction FD.

However, the distance L1 is the distance between the inner magnet 36a and the outer magnet 32 between which no d-axis is interposed. In other words, the distance L1 is set within a range that avoids crossing the d-axis. In one magnetic pole 24, the first magnet mounting holes 30 and the second magnet mounting holes 34 are provided symmetrically about the d-axis, respectively, but the distance L1 is not the distance between the inner magnet 36a and the outer magnet 32 between which the d-axis is interposed. In other words, the distance L1 is not set across the d-axis. For example, the double-headed arrow illustrated in FIG. 7B indicates the largest distance of the distances between the inner magnet 36a mounted in the second magnet mounting hole 34 provided in the region on the right side of the d-axis and the outer magnet 32 mounted in the first magnet mounting hole 30 provided in the region on the left side of the d-axis. Thus, the distance measured across the d-axis does not become the distance L1. In other words, the distance L1 is set within one region sandwiched between the d-axis and the q-axis. In FIG. 6A, the distance L1 set in the region on the right side of the d-axis is indicated by an arrow, but the distance L1 is also set in the region on the left side of the d-axis in the same manner. This also applies to distances L2 and L3, which will be described later.

The distance L2 is the shortest distance of the distances between the first magnet mounting hole 30 and the second magnet mounting hole 34 in the region located closer to the q-axis than the d-axis-side end of the inner magnet 36b in the second magnet mounting hole 34. Here, the inner magnet 36a and the inner magnet 36b are mounted in the second magnet mounting hole 34, but the distance L2 is measured for the region where the inner magnet 36b is mounted. That is, the second distance L2 is the shortest distance between the first magnet mounting hole 30 and the second magnet mounting hole 34 in the region located closer to the q-axis than the d-axis-side end of the inner magnet 36b disposed closest to the q-axis of the inner magnets 36a and 36b mounted in the second magnet mounting hole 34.

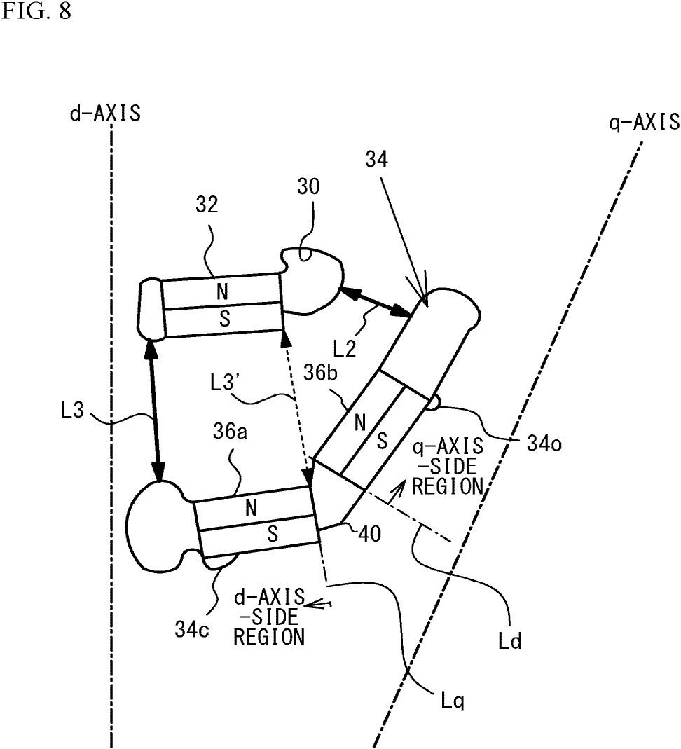

Here, with reference to FIG. 8, the left end of the inner magnet 36b corresponds to the d-axis-side end of the inner magnet 36b, and in FIG. 8, the d-axis-side end is indicated by a boundary line Ld of a chain line. In the second magnet mounting hole 34, the region located closer to the q-axis than the boundary line Ld is a region where the distance L2 is set.

The distance L3 is the shortest distance of the distances between the first magnet mounting hole 30 and the second magnet mounting hole 34 in the region located closer to the d-axis than the q-axis-side end of the inner magnet 36a in the second magnet mounting hole 34. Here, the inner magnet 36a and the inner magnet 36b are mounted in the second magnet mounting hole 34, but the distance L3 is measured for the region where the inner magnet 36a is mounted. That is, the distance L3 is the shortest distance between the first magnet mounting hole 30 and the second magnet mounting hole 34 in the region located closer to the d-axis than the q-axis-side end of the inner magnet 36a disposed closest to the d-axis of the inner magnets 36b and 36a mounted in the second magnet mounting hole 34.

With reference to FIG. 8, the right end of the inner magnet 36a corresponds to the q-axis-side end of the inner magnet 36a, and in FIG. 8, the q-axis-side end is indicated by a boundary line Lq of a chain line. In the second magnet mounting hole 34, the region located closer to the d-axis than the boundary Lq is a region where the distance L3 is set. Therefore, in the embodiment illustrated in FIG. 8, for example, a distance L3′ indicated by a dotted double-headed arrow in FIG. 8 does not indicate the shortest distance between the second magnet mounting hole 34 and the first magnet mounting hole 30, and does not become the distance L3.

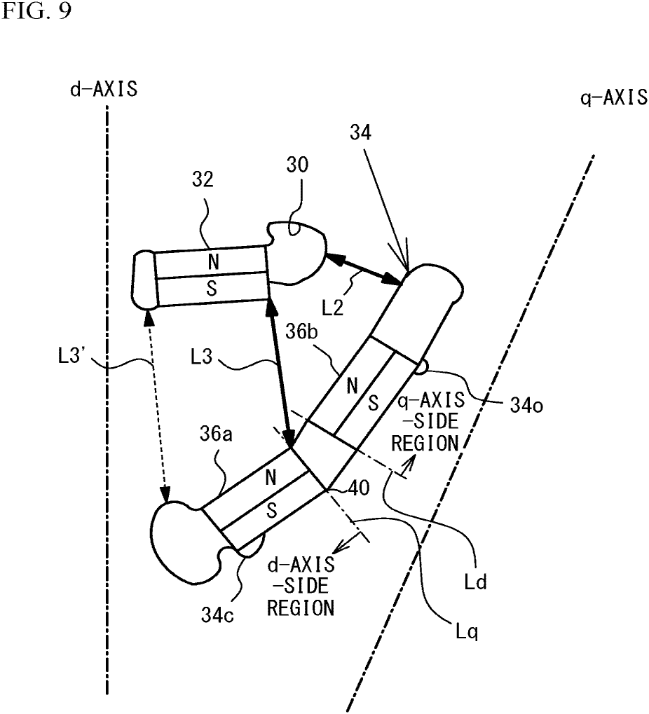

The position where the distance L3 is set varies depending on the shape and arrangement of the first magnet mounting hole 30 and the shape and arrangement of the second magnet mounting hole 34. For example, as illustrated in FIG. 9, in the case that the degree of bending of the second magnet mounting hole 34 is gentle, the distances L3′ at the position corresponding to the distance L3 illustrated in FIG. 8 is not the shortest distance, and the distance at the position corresponding to the distances L3′ in the example illustrated in FIG. 8 is the shortest distance and becomes the distance L3.

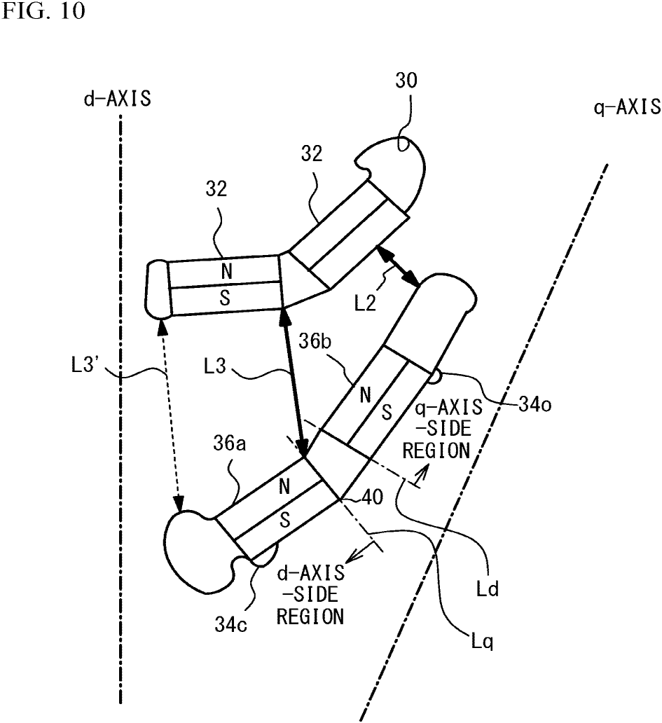

In the case that a plurality of the outer magnets 32 are mounted in the first magnet mounting hole 30 (see FIG. 10), the distance L3 is the shortest distance between the predetermined region of the second magnet mounting hole 34 described above and the region located closer to the d-axis than the q-axis-side end of the magnet disposed closest to the d-axis of the magnets mounted in the first magnet mounting hole 30. This also applies to the distance L2.

As illustrated in FIG. 8 and FIG. 9, the second magnet mounting hole 34 may have a substantially V-shaped outer shape having the center-side portion 34c and the outer-side portion 34o extending from the bending point 40 toward the outer peripheral edge of the rotor 14. In this case, the angle at the bending point 40 can be appropriately set. Further, the second magnet mounting hole 34 may be configured so that the center-side portion 34c and the outer-side portion 34o are formed substantially linearly without being bent at the bending point 40.

The second magnet mounting hole 34 is divided into a region located closer to the q-axis than the boundary line Ld and a region located closer to the d-axis than the boundary line Lq, and a space that is a region between the boundary line Ld and the boundary line Lq and in which no magnet exists functions as an intermediate flux barrier.

Next, expression (1) will be described. Expression (1) defines that the distance L3 is greater than the distance L2. If the distance L3 is set to be smaller than the distance L2, magnetic saturation occurs in the location where the distance L3 is set. In the present embodiment, expression (1) is set so that magnetic saturation does not occur in the location where the distance L3 is set as described above.

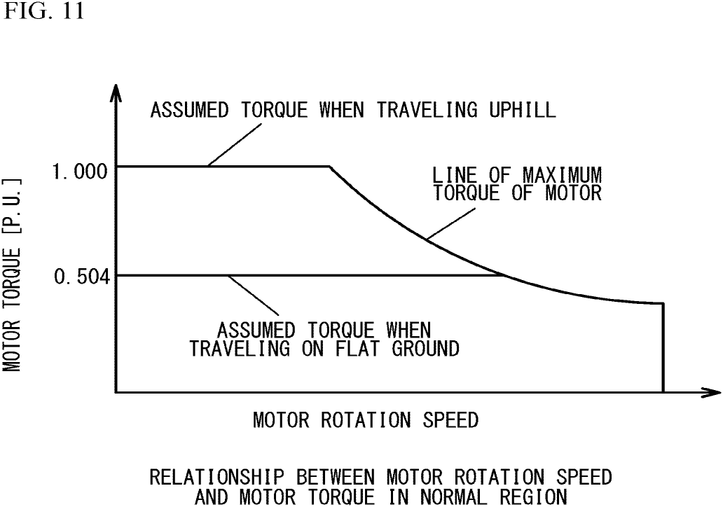

Next, the reason why expressions (2) and (3) are derived will be described. FIG. 11 presents a relationship between the motor rotation speed and the motor torque in the normal range of the rotary electric machine 10 mounted on the vehicle. In a vehicle equipped with the rotary electric machine 10, the assumed torque when the vehicle is traveling uphill is set to 1.0 [P.U.], whereas the assumed torque when the vehicle is traveling on a flat ground is set to 0.504 [P.U.]. In the following description, the output torque when travelling uphill is referred to as a torque under high load, and the output torque when travelling on a flat ground is referred to as a torque under low load.

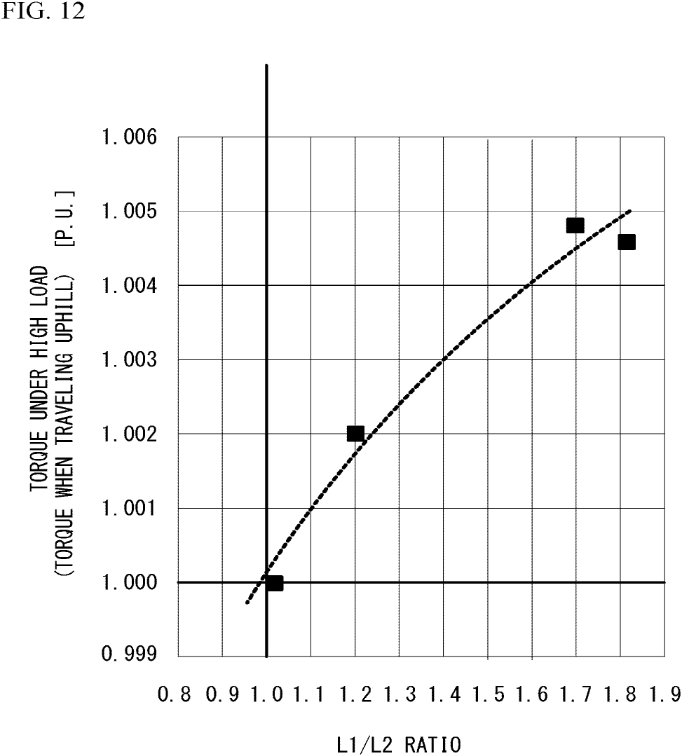

FIG. 12 presents a relationship between the L1/L2 ratio and the torque under high load [P.U.]. FIG. 12 is a graph obtained by an analysis simulation in which values of output torque are plotted for each rotor in which the L1/L2 ratio is set to different values. The torque under high load [P.U.] has a correlation with the L1/L2 ratio, and it can be seen that as the value of the L1/L2 ratio increases, a high load torque is more easily obtained. When the L1/L2 ratio is larger than 1.0, a torque of 1.00 [P.U.], which is a desired torque, can be obtained.

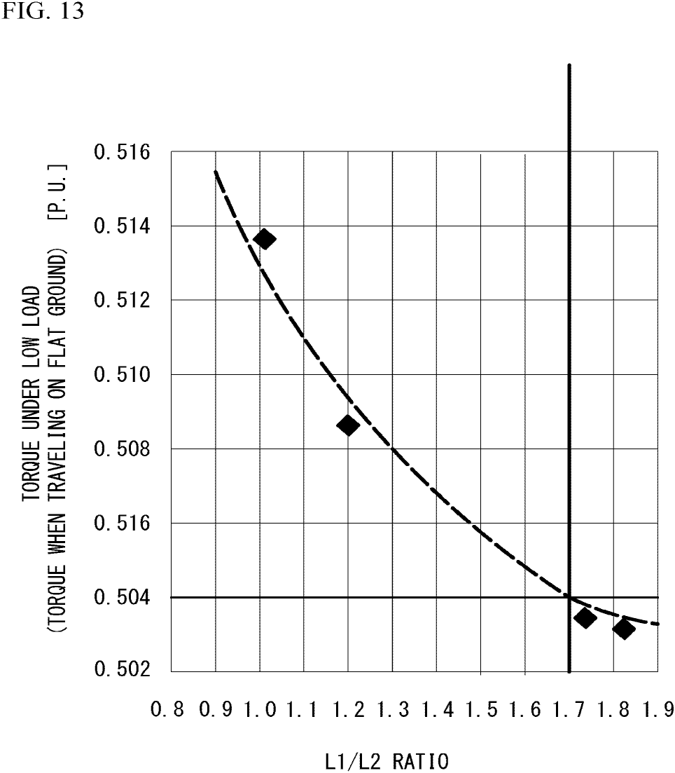

FIG. 13 presents a relationship between the L1/L2 ratio and a torque under low load [P.U.]. FIG. 13 is a graph obtained by an analysis simulation in which values of output torque are plotted for each rotor in which the L1/L2 ratio is set to different values. The torque under low load [P.U.] has a correlation with the L1/L2 ratio, and it can be seen that the obtained torque decreases as the value of the L1/L2 ratio increases. When the L1/L2 ratio is larger than 1.7, the desired torque of 0.504 [P.U.] cannot be obtained.

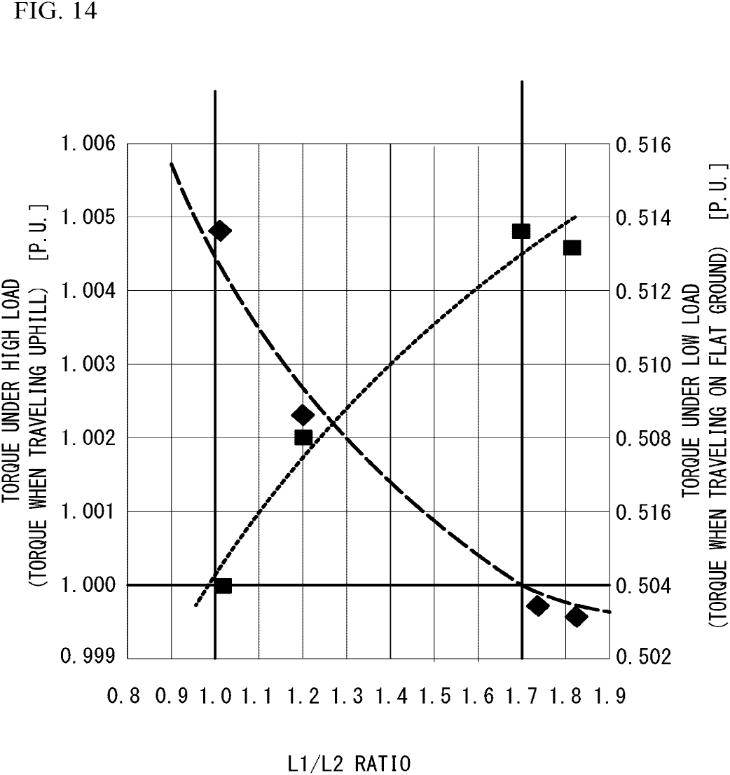

Thus, it can be seen that the L1/L2 ratio affects both the torque under high load and the torque under low load. The torque under high load and the torque under low load are related to a phenomenon that the magnetic saturation state changes with a change in the ratio between the magnet torque and the reluctance torque, and are in a trade-off relationship with the L1/L2 ratio. Therefore, as illustrated in FIG. 14, the torque under high load is plotted on one vertical axis and the torque under low load is plotted on the other vertical axis, and the range of the L1/L2 ratio capable of satisfying both requirements is determined. As a result, the range in which both requirements can be satisfied is 1.0 < L1/L2 ≤ 1.7 presented by expression (2).

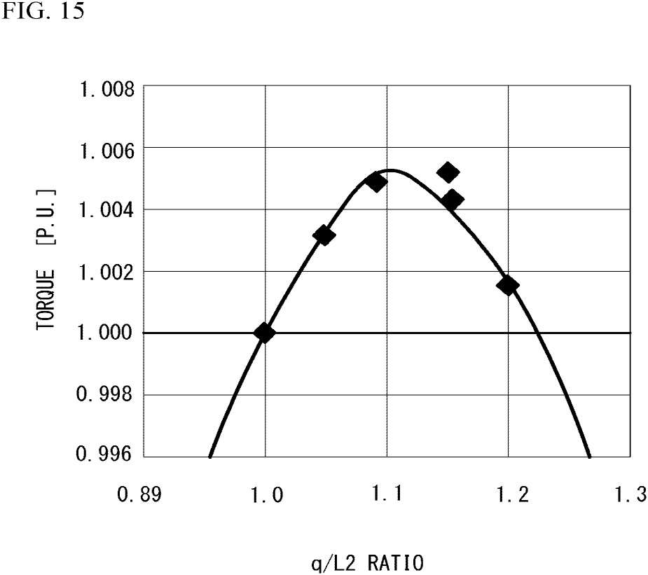

Next, expression (3) will be described. FIG. 15 presents a relationship between the q/L2 ratio and torque [P.U.]. FIG. 15 is a graph obtained by an analysis simulation in which values of output torque are plotted for each rotor in which the q/L2 ratio is set to different values. It can be seen that the torque [P.U.] has a correlation with the q/L2 ratio, and when the q/L2 ratio is within a certain range, a desired torque, that is, 1.0 [P.U.] is obtained. According to the graph presented in FIG. 15, a torque of 1.00 [P.U.] can be obtained in the range of 1.0 < q/L2 ≤ 1.225. Further, q/L2 preferably satisfies the relationship of 1.0 < q/L2 ≤ 1.1. Further, q/L2 may satisfy the relationship of q/L2 = 1.1. In particular, when the relationship of q/L2 = 1.1 is satisfied, the magnetic saturation and the magnetic leakage flux are balanced, and the obtained torque is maximized.

As described above, a desired output torque can be obtained by setting L1, L2, and q so as to satisfy expression (2): 1.0 < L1/L2 ≤ 1.7 and expression (3): 1.0 < q/L2 ≤ 1.2 within a range satisfying expression (1): L3 > L2. Specifically, a reluctance torque is easily exhibited, the magnetic saturation of each magnetic path is inhibited, and a large torque and a high output are easily obtained. In addition, since the magnetic saturation is relaxed, a high-frequency component is reduced, and low loss and low torque ripple in the rotary electric machine 10 can be ensured.

Even in the rotor 14 that satisfies only expression (2), magnetic saturation can be inhibited. By satisfying expression (3), it is possible to more effectively inhibit magnetic saturation. In this case, by satisfying expression (1), it is possible to avoid occurrence of magnetic saturation in the location where the distance L3 is set, and a desired torque is obtained because of satisfaction of expression (2) and expression (3).

In the present embodiment, the distance L1 is longer than the lengths of the long sides and the short sides of the outer magnet 32 and the inner magnet 36 as viewed in the axial direction. The distance L1 is shorter than the length of the first magnet mounting hole 30 and the combined length of the center-side portion 34c and the outer-side portion 34o of the second magnet mounting hole 34, and is longer than the width of the first magnet mounting hole 30 and the width of the second magnet mounting hole 34. The distance L2 is shorter than the lengths of the long sides of the outer magnet 32 and the inner magnet 36 as viewed in the axial direction, and is longer than the lengths of the short sides of the outer magnet 32 and the inner magnet 36 as viewed in the axial direction. The distance L2 is shorter than the length of the first magnet mounting hole 30 and the combined length of the center-side portion 34c and the outer-side portion 34o of the second magnet mounting hole 34, and is longer than the width of the first magnet mounting hole 30 and the width of the second magnet mounting holes 34. The smallest width q is wider than the lengths of the long sides and the short sides of the outer magnet 32 and the inner magnet 36 as viewed in the axial direction. The smallest width q is shorter than the lengths of the first magnet mounting hole 30 and the combined length of the center-side portion 34c and the outer-side portion 34o of the second magnet mounting hole 34, and is longer than the width of the first magnet mounting hole 30 and the width of the second magnet mounting hole 34.

### Advantages

In the rotor 14 according to the present embodiment, the relationships among the distance L1, the distance L2, and the smallest width q of the q-axis portion magnetic path 64 are set so as to satisfy expression (1): L3 > L2, expression (2): 1.0 < L1/L2 ≤ 1.7, and expression (3): 1.0 < q/L2 ≤ 1.2. This makes it possible to inhibit the occurrence of a magnetic saturation state.

### Variations

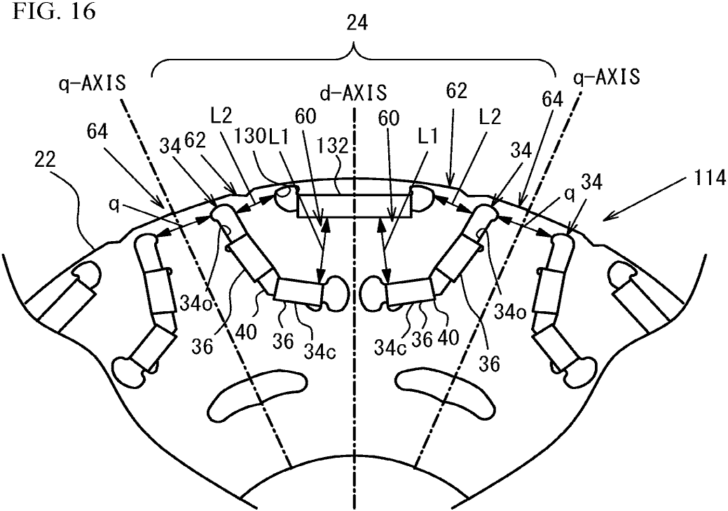

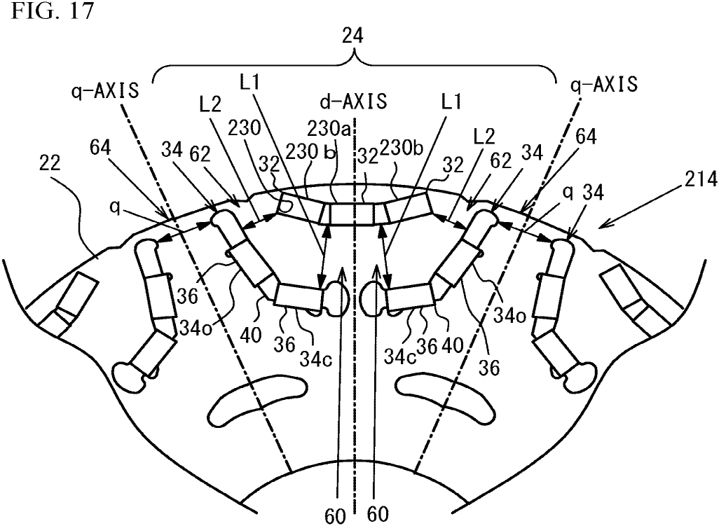

Next, variations will be described with reference to FIG. 16 and FIG. 17. In the following description, differences between each variation and the rotor 14 described in the embodiment will be mainly described, and components common to those of the rotor 14 of the embodiment are denoted by the same reference numerals in the drawings, and detailed description thereof will be omitted.

### First Variation

With reference to FIG. 16, a rotor 114 of a first variation includes first magnet mounting holes 130 and outer magnets 132 instead of the first magnet mounting holes 30 and the outer magnets 32 included in the rotor 14 of the embodiment. In the rotor 14 of the embodiment, the two first magnet mounting holes 30 are arranged symmetrically in the circumferential direction about the d-axis, whereas the first magnet mounting hole 130 in the rotor 114 is one hole through which the d-axis passes. The outer magnet 132 is also one magnet having a rectangular (substantially rectangular) shape through which the d-axis passes.

Also in the rotor 114 having such a configuration, the distances L1, L2, L3 and the smallest width q are set so as to satisfy expression (1): L3 > L2, expression (2): 1.0 < L1/L2 ≤ 1.7, and expression (3): 1.0 < q/L2 ≤ 1.2. Thus, a desired output torque can be obtained.

### Second Variation

With reference to FIG. 17, a rotor 214 of a second variation includes first magnet mounting holes 230 and the outer magnets 32 instead of the first magnet mounting holes 30 and the outer magnets 32 included in the rotor 14 of the embodiment. The first magnet mounting hole 230 includes a central mounting portion 230a through which the d-axis passes, and side mounting portions 230b extending at respective sides of the central mounting portion 230a. The outer magnets 32 are disposed in the central mounting portion 230a and the side mounting portions 230b, respectively.

Also in the rotor 214 having such a configuration, the distances L1, L2, L3 and the smallest width q are set so as to satisfy expression (1): L3 > L2, expression (2): 1.0 < L1/L2 ≤ 1.7, and expression (3): 1.0 < q/L2 ≤ 1.2. Thus, a desired output torque can be obtained.

### Third Variation

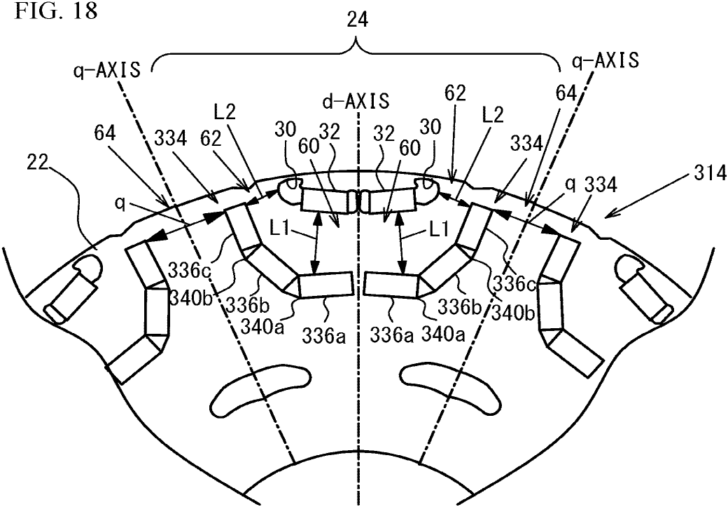

With reference to FIG. 18, a rotor 314 of a third variation includes second magnet mounting holes 334 and inner magnets 336a, 336b, and 336c instead of the second magnet mounting holes 34 and the inner magnets 36 included in the rotor 14 of the embodiment. In the rotor 14 of the embodiment, the second magnet mounting hole 34 has one bending point 40, but the rotor 314 has two bending points 340a and 340b. The inner magnets 340a, 340b, and 336c are disposed in regions formed by bending at the bending points 336a and 336b, respectively.

Also in the rotor 314 having such a configuration, the distances L1, L2, L3 and the smallest width q are set so as to satisfy expression (1): L3 > L2, expression (2): 1.0 < L1/L2 ≤ 1.7, and expression (3): 1.0 < q/L2 ≤ 1.2. Thus, a desired output torque can be obtained. Further, q/L2 preferably satisfies the relationship of 1.0 < q/L2 ≤ 1.1. Further, it is desirable that q/L2 satisfies the relationship of q/L2 = 1.1.

Although some embodiments of the present invention have been described in detail, the present invention is not limited to the specific embodiments but may be varied or changed within the scope of the present invention as claimed.

What is claimed is:

1. A rotor that is rotatably and concentrically disposed inside a stator and in which a plurality of magnetic poles arranged in a circumferential direction with a q-axis interposed therebetween are formed, the rotor comprising:
a rotor core in which magnet mounting holes, which are provided symmetrically in a circumferential direction about a d-axis, are provided in a plurality of layers along a radial direction for each of the magnetic poles; and
magnets disposed in the magnet mounting holes,
wherein the magnet mounting holes provided in the plurality of layers along the radial direction include a first magnet mounting hole and a second magnet mounting hole, the second magnet mounting hole is located further inward than the first magnet mounting hole in the radial direction, and the first magnet mounting hole and the second magnet mounting hole satisfy a positional relationship defined by the following expressions:
$$\text{L3 > L2}$$
$$\text{1} \text{.0 < L1} / \text{L2} \leq \text{1} \text{.7}$$
where L1 represents a largest distance of distances between a first magnet and a second magnet along a direction in which a magnetic flux flows from a north pole to a south pole of the first magnet, the first magnet being a magnet disposed closest to the d-axis among the magnets mounted in the second magnet mounting hole, the second magnet being a magnet mounted in the first magnet mounting hole among the magnets, the largest distance L1 being not intersecting with the d-axis, L2 represents a shortest distance of distances between the first magnet mounting hole and the second magnet mounting hole in a region located closer to the q-axis than a d-axis-side end of a third magnet in the second magnet mounting hole, the third magnet being a magnet disposed closest to the q-axis among the magnets mounted in the second magnet mounting hole, and L3 represents a shortest distance of distances between the first magnet mounting hole and the second magnet mounting hole in a region located closer to the d-axis than a q-axis-side end of a fourth magnet in the second magnet mounting hole, the fourth magnet being a magnet disposed closest to the d-axis among the magnets mounted in the second magnet mounting hole.

2. The rotor according to claim 1, wherein the rotor core includes a q-axis portion magnetic path that connects the second magnet mounting holes adjacent to each other across the q-axis, and a relationship defined by the following expression:
$$\text{1} \text{.0 < q} / \text{L2} \leq \text{1} \text{.2}$$
is further satisfied where q represents a smallest width of the q-axis portion magnetic path.

3. The rotor according to claim 1, wherein in one of the magnetic poles, the first magnet mounting hole is provided in a plurality, the first magnet mounting holes are provided symmetrically in the circumferential direction about the d-axis across an outer-side center bridge through which the d-axis passes, and one or more of the magnets is disposed in each of the first magnet mounting holes.

4. The rotor according to claim 1, wherein in one of the magnetic poles, the first magnet mounting hole is one hole through which the d-axis passes, and one of the magnets is disposed in the one hole, the one of the magnets having a rectangular shape, the d-axis passing through the one of the magnets.

5. The rotor according to claim 1, wherein in one of the magnetic poles, the first magnet mounting hole includes a central mounting portion through which the d-axis passes and side mounting portions extending at respective sides of the central mounting portion, and the magnets are disposed in the central mounting portion and the side mounting portions, respectively.

6. The rotor according to claim 1, wherein in one of the magnetic poles, the second magnet mounting hole is provided in a plurality, the second magnet mounting holes are provided symmetrically in the circumferential direction about the d-axis across an inner-side center bridge through which the d-axis passes, and one or more of the magnets are disposed in each of the second magnet mounting holes.

7. The rotor according to claim 5, wherein two or more of the magnets are disposed in the second magnet mounting hole in a plurality.

8. The rotor according to claim 1, wherein in one of the magnetic poles, the second magnet mounting hole has a polygonal line shape having one or more bending points as viewed in an axial direction, and one or more of the magnets are provided in each of regions on both sides of the bending points.

9. The rotor according to claim 1, wherein each of the magnets has a curved shape as viewed in an axial direction.

10. A rotary electric machine, comprising the rotor according to claim 1.
